(19) United States
(12) Patent Application Publication
(10) Pub. No.: US 2019/0186593 A1
(43) Pub. Date: Jun. 20, 2019

(54) TORQUE FLUCTUATION INHIBITING DEVICE, TORQUE CONVERTER AND POWER TRANSMISSION DEVICE

(71) Applicant: EXEDY Corporation, Osaka (JP)

(72) Inventors: Yuki KAWAHARA, Osaka (JP); Naoki TOMIYAMA, Osaka (JP); Yusuke TOMITA, Osaka (JP)

(73) Assignee: EXEDY Corporation

(21) Appl. No.: 16/214,616

(22) Filed: Dec. 10, 2018

(30) Foreign Application Priority Data
Dec. 19, 2017 (JP) 2017-243112

(51) Int. Cl. F16F 15/134; F16F 15/133; F16F 15/31; F16F 15/14; F16H 45/02

(52) U.S. Cl. CPC F16F 15/13469; F16F 15/1337; F16F 15/31; F16H 2045/0263; F16H 45/02; F16F 2230/0064; F16F 15/145

(57) ABSTRACT

A torque fluctuation inhibiting device includes a first rotating body, a second rotating body, a centrifugal element, a support portion, and a displacement inhibiting mechanism. Torque is input to the first rotating body. The centrifugal element is subject to centrifugal force due to rotation of the first rotating body and moves in a direction different from a direction in which the centrifugal force acts. The support portion is provided in the first rotating body or the second rotating body and moveably guides the centrifugal element in the direction different from the direction in which the centrifugal force acts on the centrifugal element. The displacement inhibiting mechanism generates circumferential force which reduces a relative displacement of the first rotating body and the second rotating body when the centrifugal element moves in the direction different from the direction in which the centrifugal force acts on the centrifugal element.

### CROSS-REFERENCES TO RELATED APPLICATIONS

This application claims priority to Japanese Patent Application No. 2017-243112, filed Dec. 19, 2017. The contents of that application are herein incorporated by reference in their entirety.

### BACKGROUND

### Technical Field

The present disclosure relates to a torque fluctuation inhibiting device, in particular, to a torque fluctuation inhibiting device configured to inhibit torque fluctuation. The present disclosure also relates to a torque converter and a power transmission device both including the torque fluctuation inhibiting device.

### Background Art

A clutch device or a torque converter including a damper device is provided, for example, between the engine and the transmission of an automobile. The torque converter is provided with a lock-up device used for mechanically transmitting torque at a predetermined rotational speed or higher in order to reduce fuel consumption.

Japanese Patent Unexamined Publication 2017-053467 discloses a lock-up device including a torque fluctuation inhibiting device. The torque fluctuation inhibiting device in Japanese Patent Unexamined Publication 2017-053467 includes an inertia ring, a plurality of centrifugal elements and a plurality of cam mechanisms. The inertia ring can rotate relative to a hub flange to which torque is transmitted, and the centrifugal elements are subject to centrifugal force due to rotation of the hub flange and the inertia ring. The cam mechanism includes a cam formed on a surface of the centrifugal element and a cam follower which makes contact with the cam.

With the device in Japanese Patent Unexamined Publication 2017-053467, if torque fluctuation causes displacement in a rotational direction between the hub flange and the inertia ring, the cam mechanism operates as a result of centrifugal force acting on the centrifugal element. In addition, the centrifugal force acting on the centrifugal element is converted to circumferential force which reduces the displacement between the hub flange and the inertia ring. This circumferential force inhibits torque fluctuation.

### BRIEF SUMMARY

With the torque fluctuation inhibiting device in Japanese Patent Unexamined Publication 2017-053467, a plurality of recesses open externally in a radial direction are formed on an outer peripheral portion of the hub flange, and the centrifugal elements are housed in these recesses in a manner that allows the centrifugal elements to move in the radial direction. With this configuration, gaps are formed between both circumferential sides of the centrifugal elements and wall portions of the recesses which oppose the sides of the centrifugal elements. It is structurally difficult to eliminate these gaps.

In the torque fluctuation inhibiting device as described above, the gaps formed between the centrifugal elements and the recesses may cause the centrifugal elements to randomly move in the circumferential direction or randomly rotate and change orientation while the device is operating.

Here, when the centrifugal elements randomly move or change orientation within the range of the gaps, hysteresis occurs in the torsional characteristics (characteristics indicating the relationship between a relative rotational angle formed between the hub flange and the inertia ring and torque transmitted between the hub flange and the inertia ring) of the torque fluctuation inhibiting device. Hysteresis reduces the effect of inhibiting torque fluctuation (that is, the ability to dampen torque fluctuation).

In addition, if the centrifugal elements randomly move or change orientation within the range of the gaps, the profiles of the cams formed in the centrifugal elements also randomly change, and torsional characteristics in terms of design cannot be appropriately obtained. In other words, the above-mentioned gaps cause torsional characteristics to be unstable, that is, the ability to dampen torque fluctuation to be unstable.

It is an objective of the present disclosure to provide a torque fluctuation inhibiting device that is capable of stably maintaining torque fluctuation dampening ability.

### Solution to Problem

(1) A torque fluctuation inhibiting device according to one aspect of the present disclosure is a torque fluctuation inhibiting device configured to inhibit torque fluctuation.

This torque fluctuation inhibiting device includes a first rotating body, a second rotating body, a centrifugal element, a support portion and a displacement inhibiting mechanism. Torque is input to the first rotating body. The second rotating body is rotatably disposed relative to the first rotating body. The centrifugal element is subject to centrifugal force due to rotation of the first rotating body and is configured to move in a direction different from a direction in which the centrifugal force acts. The support portion is provided to the first rotating body or the second rotating body and is configured to moveably guide the centrifugal element in the direction different from the direction in which the centrifugal force acts on the centrifugal element. The displacement inhibiting mechanism is configured to generate circumferential force which reduces relative displacement of the first rotating body and the second rotating body when the centrifugal element moves in the direction different from the direction in which the centrifugal force acts on the centrifugal element.

With this torque fluctuation inhibiting device, the first rotating body and the second rotating body rotate when torque is input to the first rotating body. If the torque input to the first rotating body does not fluctuate, no phase displacement in the rotational direction occurs between the first rotating body and the second rotating body. In contrast, if the input torque fluctuates, because the second rotating body is rotatably disposed relative to the first rotating body, relative displacement (hereinafter sometimes referred to as “rotational phase difference”) in the rotational direction occurs between the first rotating body and the second rotating body according to the degree of torque fluctuation.

Here, when the first rotating body and the second rotating body rotate, the centrifugal element is subject to the centrifugal force. The centrifugal force acts on the centrifugal element in the radial direction to move the centrifugal element in the direction different from the direction in which the centrifugal force acts on the centrifugal element. With this configuration, when relative displacement in the rotational direction occurs between the first rotating body and the second rotating body, the displacement inhibiting mechanism generates circumferential force which reduces the relative displacement between the first rotating body and the second rotating body. The displacement inhibiting mechanism inhibits torque fluctuation.

Here, the centrifugal force acting on the centrifugal element is used as force for inhibiting torque fluctuation. Because of this, characteristics for inhibiting torque fluctuation fluctuate depending on rotational speed of the rotating body. Further, characteristics for inhibiting torque fluctuation can be appropriately set and torque fluctuation peaks in wider rotational speed ranges can be inhibited based on, for example, the shape of the cam.

In addition, the centrifugal force acts on the centrifugal element in the radial direction and the centrifugal element moves in the direction different from the direction in which the centrifugal force acts on the centrifugal element. With this configuration, if the above-described gaps exist, the orientation of the centrifugal element changes relative to the support portion within the range of the gap. Under this state, the centrifugal element moves in the direction different from the direction in which the centrifugal force acts on the centrifugal element. As a result, even if a gap exists between the centrifugal element and the support portion, the centrifugal element moves relative to the support portion under a state in which the orientation of the centrifugal element is maintained relative to the support portion.

With this configuration, hysteresis in the torsional characteristics is inhibited, and hence a reduction in torque fluctuation dampening ability can be avoided. In addition, torque fluctuation dampening ability can be stabilized. In other words, with the present torque fluctuation inhibiting device, torque fluctuation dampening ability can be stably maintained.

(2) In a torque fluctuation inhibiting device according to another aspect of the present disclosure, the support portion preferably includes a first wall portion extending in the direction different from the direction in which the centrifugal force acts on the centrifugal element, and a second wall portion opposing the first wall portion in a circumferential direction. Here, the centrifugal element is disposed between the first wall portion and the second wall portion. The centrifugal element is movable in the direction different from the direction in which the centrifugal force acts on the centrifugal element along at least one of the first wall portion and the second wall portion.

With this configuration, the centrifugal element can be suitably moved in the direction different from the direction in which the centrifugal force acts on the centrifugal element. As a result, torque fluctuation dampening ability can be stably maintained.

(3) In a torque fluctuation inhibiting device according to another aspect of the present disclosure, the centrifugal element is preferably subject to turning moment about an axis parallel to a center of rotation of the first rotating body, so as to make contact with the support portion.

In this case, turning moment due to the component force of the centrifugal force acts on the centrifugal element by allowing the support portion to guide the centrifugal element as described above. When this happens, the orientation of the centrifugal element changes and the centrifugal element makes contact with the support portion. As a result, the orientation of the centrifugal element can be maintained relative to the support portion and the centrifugal element can be moved along the support portion. In other words, torque fluctuation dampening ability can be stably maintained.

(4) In a torque fluctuation inhibiting device according to another aspect of the present disclosure, the centrifugal element preferably includes a first centrifugal element subject to a first turning moment, and a second centrifugal element subject to a second turning moment opposite to the first turning moment.

In this case, torsional characteristics resulting from the first centrifugal element and torsional characteristics resulting from the second centrifugal element combine, and hence more suitable torsional characteristics can be realized. In other words, torque fluctuation dampening ability can be stably maintained.

(5) In a torque fluctuation inhibiting device according to another aspect of the present disclosure, with a first straight line connecting the center of rotation of the first rotating body and a center of gravity of the centrifugal element as a reference, the centrifugal element disposed on a first rotational direction side and the centrifugal element disposed on a second rotational direction side opposite to the first rotational direction side have substantially the same mass.

Even with such a configuration, the centrifugal element is guided to the support portion as described above, to thereby maintain the orientation of the centrifugal element relative to the support portion. With this configuration, torque fluctuation dampening ability can be stably maintained.

(6) In a torque fluctuation inhibiting device according to another aspect of the present disclosure, with a first straight line connecting the center of rotation of the first rotating body and a center of gravity of the centrifugal element as a reference, the centrifugal element disposed on a first rotational direction side and the centrifugal element disposed on a second rotational direction side opposite to the first rotational direction side have different masses.

With this configuration, the orientation of the centrifugal element can easily be changed and maintained relative to the support portion. As a result, torque fluctuation dampening ability can be stably maintained.

(7) In a torque fluctuation inhibiting device according to another aspect of the present disclosure, the torque fluctuation inhibiting device preferably includes a cam mechanism. Here, the cam mechanism is configured to, when relative displacement occurs in a rotational direction between the first rotating body and the second rotating body, convert the centrifugal force into circumferential force in a direction in which the relative displacement reduces.

In this case, through use of the cam mechanism, the centrifugal force can be effectively converted into circumferential force in a direction in which relative displacement reduces. In other words, torque fluctuation dampening ability can be stably maintained.

(8) In a torque fluctuation inhibiting device according to another aspect of the present disclosure, the cam mechanism includes a cam and a cam follower. The cam is provided in one of the second rotating body and the centrifugal element. The cam follower is provided in the other of the second rotating body and the centrifugal element and is configured to move along the cam.

Even with such a configuration, torque fluctuation dampening ability can be stably maintained.

(9) In a torque fluctuation inhibiting device according to another aspect of the present disclosure, the direction different from the direction in which the centrifugal force acts on the centrifugal element preferably differs from a direction in which a second straight line extends. The second straight line is a straight line which connects the center of rotation of the first rotating body and a point of contact between the cam and the cam follower under a state subject to the centrifugal force with no relative displacement.

With this configuration, the centrifugal element can be favorably moved in the direction different from the direction in which the centrifugal force acts on the centrifugal element. As a result, torque fluctuation dampening ability can be stably maintained.

(10) In a torque fluctuation inhibiting device according to another aspect of the present disclosure, an outer peripheral surface of the first rotating body preferably includes a plurality of recesses open externally in a radial direction. The centrifugal element is housed in the recess. The centrifugal element includes a first guide roller rotatably mounted to a first side portion in the circumferential direction, and a second guide roller rotatably mounted to a second side portion in the circumferential direction. The support portion includes a first wall portion in the recess against which the first guide roller abuts, and a second wall portion in the recess against which the second guide roller abuts.

With this configuration, in the centrifugal element, the first guide roller makes contact with the first wall portion of the recess and the second guide roller makes contact with the second wall portion of the recess. Therefore, the orientation of the centrifugal element can be maintained relative to the support portion. As a result, torque fluctuation dampening ability can be stably maintained.

(11) In a torque fluctuation inhibiting device according to another aspect of the present disclosure, the first guide roller and the second guide roller each preferably include an outer peripheral roller and an inner peripheral roller disposed radially inward of the outer peripheral roller.

With this configuration, the centrifugal element can be stably moved along the first and second wall portions of the recess. As a result, torque fluctuation dampening ability can be stably maintained.

(12) In a torque fluctuation inhibiting device according to another aspect of the present disclosure, the second rotating body preferably includes a first inertia ring and a second inertia ring sandwiching and opposing the first rotating body, and a pin linking the first inertia ring and the second inertia ring such that the first inertia ring and the second inertia ring are unrotatable relative to each other. Here, the centrifugal element is disposed between the first inertia ring and the second inertia ring in the axial direction at an outer peripheral portion of the first rotating body and on an inner peripheral side of the pin.

With this configuration, the cam mechanism can be made simple and compact.

(13) A torque fluctuation inhibiting device according to one aspect of the present disclosure is a torque converter disposed between an engine and a transmission.

The torque converter includes an input-side rotational body to which torque from an engine is input; an output-side rotational body which outputs torque to the transmission; a damper disposed between the input-side rotational body and a turbine; and the torque fluctuation inhibiting device of any one of items (1) to (12) above.

(14) A torque fluctuation inhibiting device according to one aspect of the present disclosure includes a flywheel; a clutch device provided to the second inertial body of the flywheel; and the torque fluctuation inhibiting device of any one of items (1) to (12) above. Here, the flywheel includes a first inertial body which rotates about a rotational axis, a second inertial body which rotates about the rotational axis and rotates relative to the first inertial body, and a damper disposed between the first inertial body and the second inertial body.

With the present advancement, the ability to dampen torque fluctuation can be stably maintained in a torque fluctuation inhibiting device.

### BRIEF DESCRIPTION OF THE DRAWINGS

FIG. 1 is a schematic diagram for illustrating a torque converter according to a first embodiment of the present disclosure.

FIG. 2 is a front view for schematically illustrating a hub flange and a cam mechanism shown in FIG. 1.

FIG. 3 is a partial front view for illustrating the hub flange and a torque fluctuation inhibiting device shown in FIG. 1.

FIG. 4 is a diagram as seen from the arrow A in FIG. 2.

FIG. 5 is an external perspective view of the portion shown in FIG. 2.

FIG. 6A is a diagram for explaining component force of centrifugal force acting on a first centrifugal element.

FIG. 6B is a diagram for explaining component force of centrifugal force acting on a second centrifugal element.

FIG. 7 is a diagram for explaining operation of the cam mechanism.

FIG. 8 is a graph for showing torsional characteristics of a first cam mechanism and a second cam mechanism.

FIG. 9 is a graph for showing composite torsional characteristics of the first cam mechanism and the second cam mechanism.

FIG. 10 is a characteristic diagram for showing the relationship between rotational speed and torque fluctuation.

FIG. 11 is a diagram corresponding to FIG. 2 showing the first embodiment for illustrating a second embodiment of the present disclosure.

FIG. 12 is a diagram corresponding to FIG. 6 showing the first embodiment for illustrating the second embodiment of the present disclosure.

FIG. 13 is a diagram corresponding to FIG. 8 showing the first embodiment for illustrating the second embodiment of the present disclosure.

FIG. 14 is a diagram corresponding to FIG. 9 showing the first embodiment for illustrating the second embodiment of the present disclosure.

FIG. 15 is a schematic diagram for illustrating an Application Example 1 of the present disclosure.

FIG. 16 is a schematic diagram for illustrating an Application Example 2 of the present disclosure.

FIG. 17 is a schematic diagram for illustrating an Application Example 3 of the present disclosure.

FIG. 18 is a schematic diagram for illustrating an Application Example 4 of the present disclosure.

FIG. 19 is a schematic diagram for illustrating an Application Example 5 of the present disclosure.

FIG. 20 is a schematic diagram for illustrating an Application Example 6 of the present disclosure.

FIG. 21 is a schematic diagram for illustrating an Application Example 7 of the present disclosure.

FIG. 22 is a schematic diagram for illustrating an Application Example 8 of the present disclosure.

FIG. 23 is a schematic diagram for illustrating an Application Example 9 of the present disclosure.

### DETAILED DESCRIPTION OF EMBODIMENTS

### First Embodiment

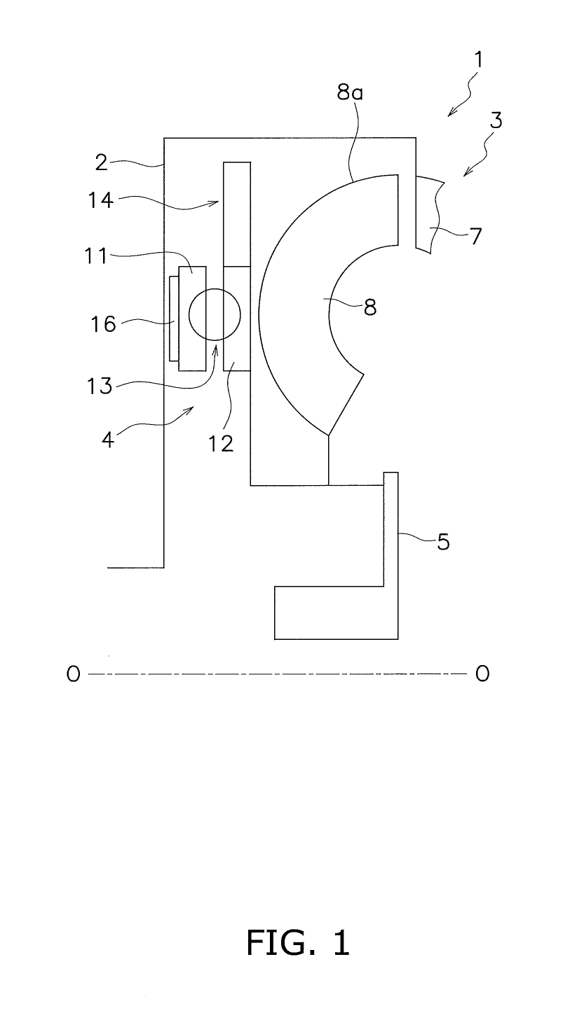

FIG. 1 is a schematic diagram for illustrating a case where a torque fluctuation inhibiting device 14 according to a first embodiment of the present disclosure is mounted to a lock-up device in a torque converter. In FIG. 1, the line O-O represents the rotational axis of the torque converter.

[Overall Configuration]

A torque converter 1 includes a front cover 2, a torque converter body 3, a lock-up device 4 and an output hub 5. Torque from an engine is input to the front cover 2. The torque converter body 3 includes an impeller 7 connected to the front cover 2, a turbine 8 and a stator (not shown). The turbine 8 is connected to the output hub 5 and engages with an inner peripheral portion of the output hub 5 because the input axis (not shown) of the transmission is a spline.

A center of rotation O is defined in this embodiment. The center of rotation O is the center of rotation of the torque converter 1. More specifically, the center of rotation O is the center of rotation of each of the front cover 2, the torque converter body 3, the lock-up device 4 (for example, an input-side rotational body 11, a hub flange 12 and the torque fluctuation inhibiting device 14 to be described later) and the output hub 5. The center of rotation O is sometimes described as the rotational axis of each component.

The terms “axial direction”, “radial direction”, “circumferential direction (circumference direction)” and “rotational direction” are defined with the center of rotation O as a reference. “Axial direction” is a direction in which the center of rotation O extends and corresponds to the direction along the center of rotation O. “Radial direction” is a direction separating from the center of rotation O and, for example, corresponds to the radial direction of a circle centered about the center of rotation O.

“Circumferential direction (circumference direction)” is a direction about the center of rotation O and, for example, corresponds to the circumferential direction of a circle centered about the center of rotation O. “Rotational direction” substantially corresponds to the “circumferential direction”. “Rotational direction” may be divided into a first rotational direction R1 and a second rotational direction R2 opposite to the first rotational direction R1.

[Lock-Up Device]

The lock-up device 4 includes a clutch portion, a piston which operates using hydraulic pressure, and other components. The lock-up device 4 includes a lock-up on state and a lock-up off state.

In the lock-up on state, torque input to the front cover 2 is transmitted to the output hub 5 through the lock-up device 4 without passing through the torque converter body 3. In contrast, in the lock-up off state, the torque input to the front cover 2 is transmitted to the output hub 5 via the torque converter body 3.

As illustrated in FIG. 1, the lock-up device 4 includes the input-side rotational body 11, the hub flange 12 (rotational body), a damper 13 and the torque fluctuation inhibiting device 14.

The input-side rotational body 11 includes a piston which is configured to move in the axial direction. A friction member 16 is fixed to a side surface of the input-side rotational body 11 on the side of the front cover 2. Torque is transmitted from the front cover 2 to the input-side rotational body 11 when the friction member 16 is pressed against the front cover 2. This state is the lock-up on state.

The hub flange 12 is disposed opposing the input-side rotational body 11 in the axial direction and rotates relative to the input-side rotational body 11. The hub flange 12 is linked to the output hub 5.

The damper 13 is disposed between the input-side rotational body 11 and the hub flange 12. The damper 13 has a plurality of torsion springs and elastically connects the input-side rotational body 11 and the hub flange 12 to each other in the rotational direction. The damper 13 allows torque to be transmitted from the input-side rotational body 11 to the hub flange 12 and absorbs/dampens torque fluctuation.

[Torque Fluctuation Inhibiting Device]

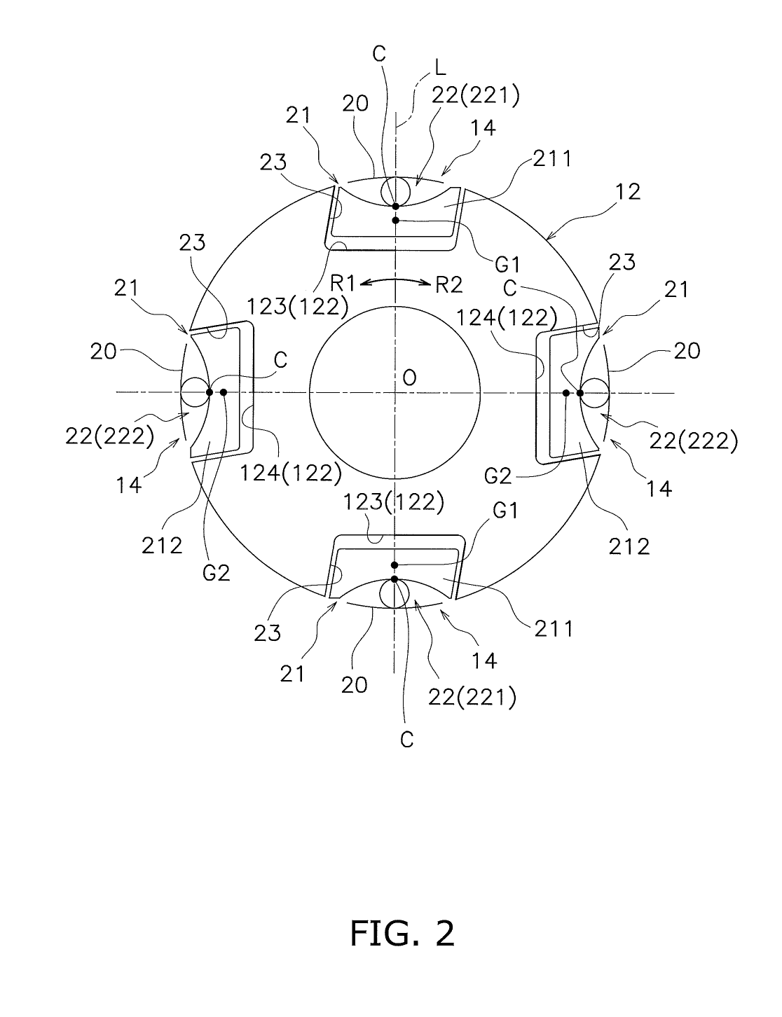

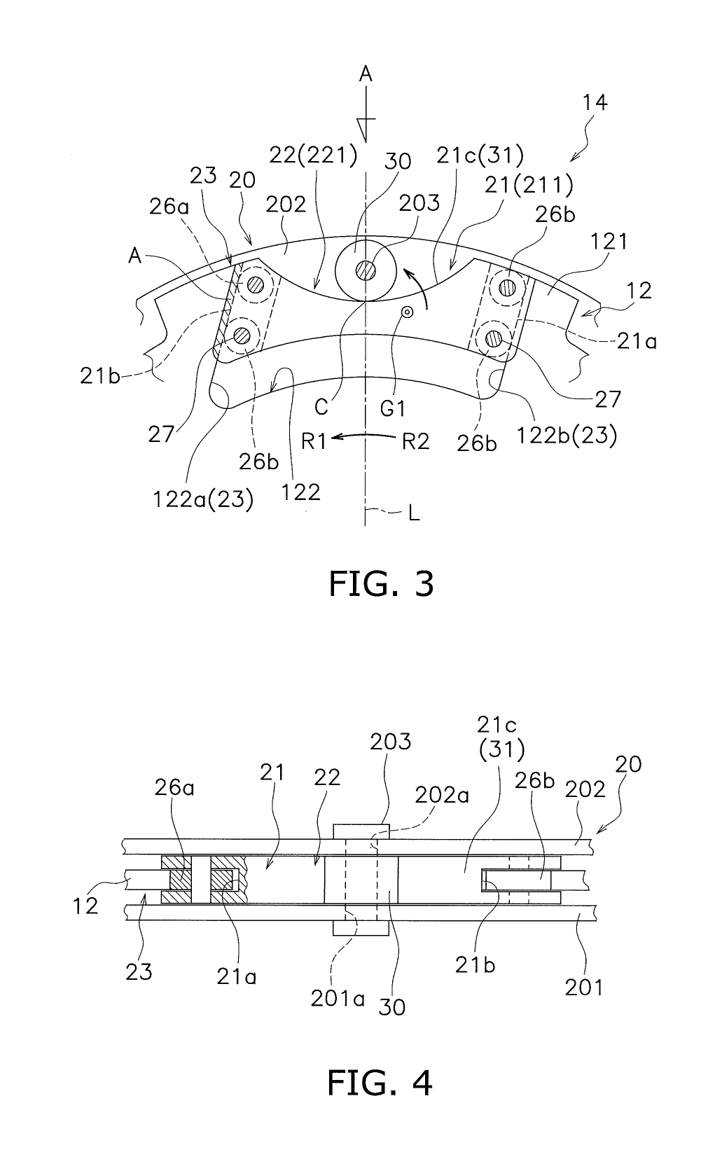

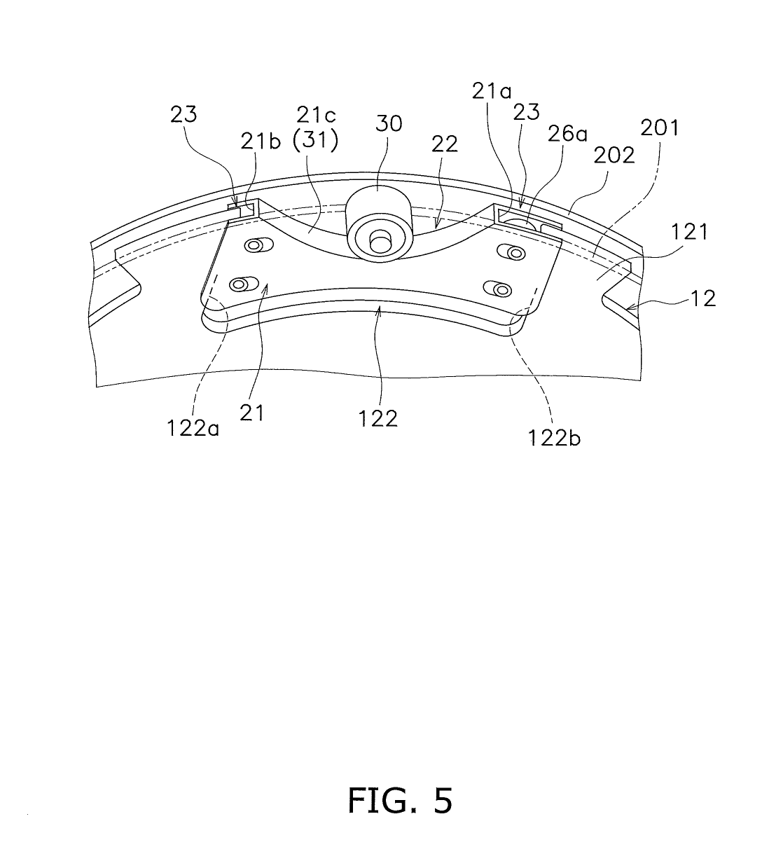

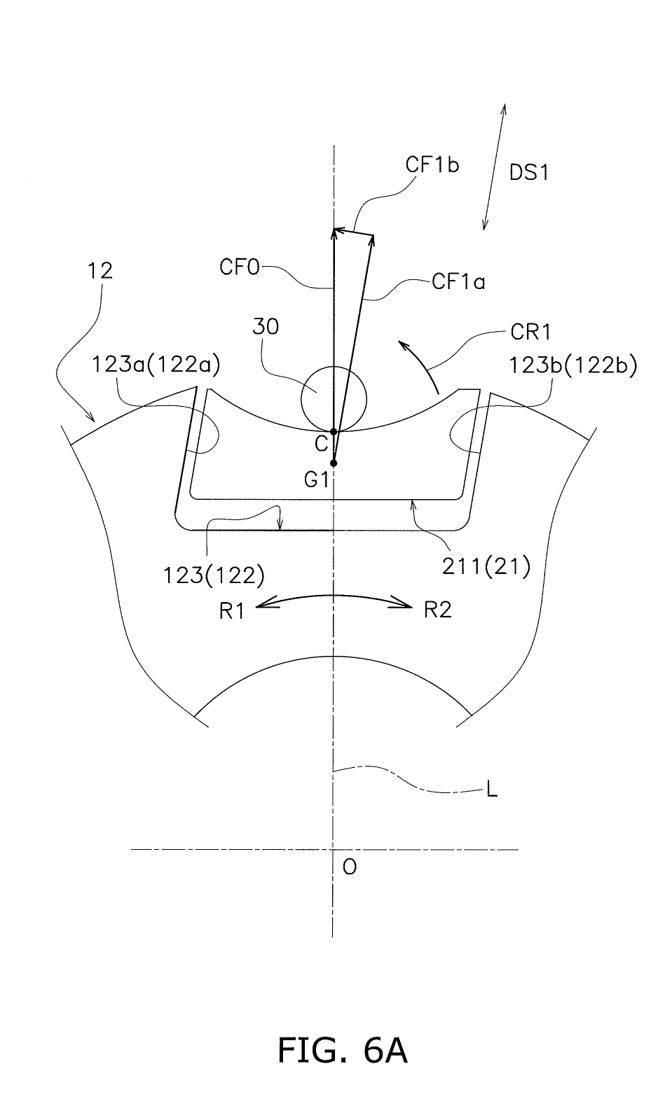

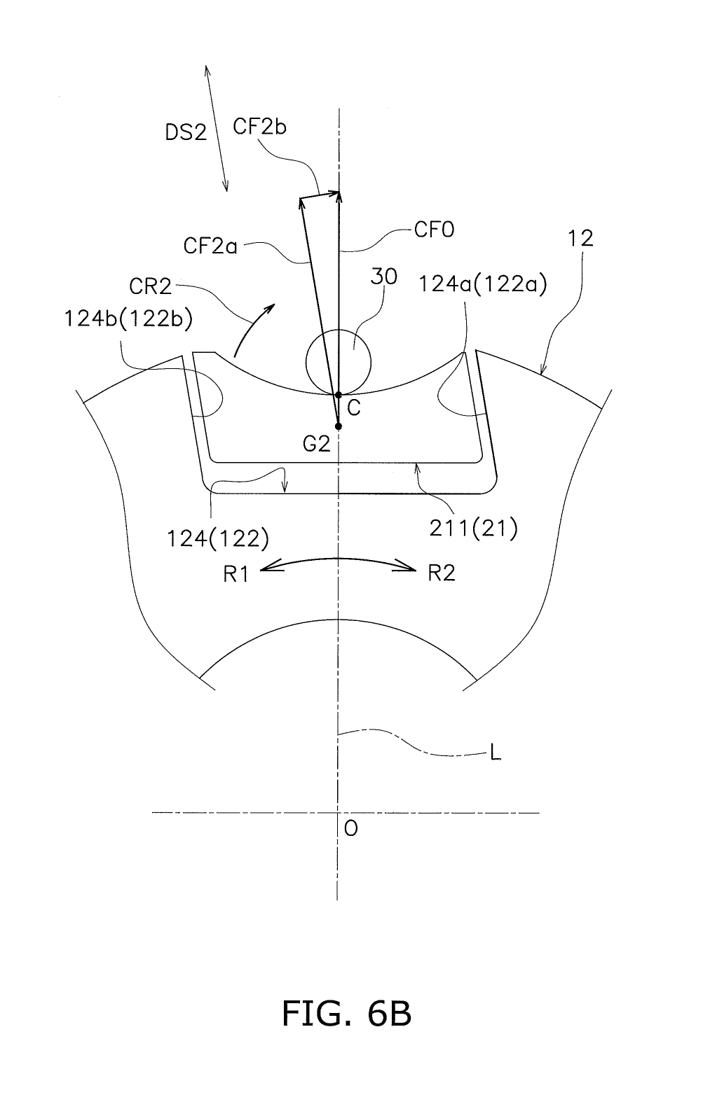

FIGS. 2 to 6B illustrate the torque fluctuation inhibiting device 14. FIG. 2 is a front view for schematically illustrating the hub flange 12 and the torque fluctuation inhibiting device 14. FIG. 3 is a diagram for illustrating in detail the torque fluctuation inhibiting device 14 shown in FIG. 2. FIG. 4 is a diagram showing FIG. 3 from an A direction. FIG. 5 is an external perspective view of FIG. 4. FIGS. 6A and 6B are diagrams for illustrating the torque fluctuation inhibiting device 14 shown in FIG. 2 in an enlarged manner. Note that in FIGS. 2 to 4 and FIG. 6, one inertia ring 20 (inertia ring 20 on the near side) has been removed.

As illustrated in FIG. 2, the torque fluctuation inhibiting device 14 includes the hub flange 12, inertia rings 20 as mass bodies, four centrifugal elements 21, four cam mechanisms 22 (example of displacement inhibiting mechanism) and a plurality of support portions 23.

[Inertia Ring]

As illustrated in FIGS. 2 to 5, the inertia ring 20 includes a first inertia ring 201 and a second inertia ring 202.

The first and second inertia rings 201 and 202 are plates with a predetermined thickness and are formed into continuous annular shapes. As illustrated in FIGS. 3 and 5, the first and second inertia rings 201 and 202 are disposed on both sides of the hub flange 12 in the axial direction with a predetermined gap therebetween. In other words, the hub flange 12 and the first and second inertia rings 201 and 202 are all disposed along the axial direction.

The first and second inertia rings 201 and 202 have the same rotational axis as the hub flange 12. The first and second inertia rings 201 and 202 rotate along with the hub flange 12 and are configured so as to rotate relative to the hub flange 12.

As illustrated in FIG. 4, the first and second inertia rings 201 and 202 are formed with holes 201a and 202a which penetrate the first and second inertia rings 201 and 202 in the axial direction. The first inertia ring 201 and the second inertia ring 202 are fixed using rivets 203 which penetrate the holes 201a and 202a . Therefore, the first inertia ring 201 is not movable relative to the second inertia ring 202 in any of the axial direction, the radial direction or the rotational direction.

[Hub Flange]

As illustrated in FIGS. 1 and 2, the hub flange 12 is formed into a circular plate. As described above, the inner peripheral portion of the hub flange 12 is connected to the output hub 5. As illustrated in FIGS. 3 and 5, four protrusions 121 with predetermined widths in the circumferential direction are formed on an outer peripheral portion of the hub flange 12, the protrusions 121 being protruding further than the outer peripheral portion.

A recess 122 with a predetermined width is formed at the center of each protrusion 121 in the circumferential direction. Each recess 122 is formed so as to be open radially outward and has a predetermined depth. Each recess 122 has first and second side walls 122a and 122b which oppose each other in the circumferential direction. The first and second side walls 122a and 122b guide the centrifugal element 21.

As illustrated in FIGS. 6A and 6B, the first and second side walls 122a and 122b extend in directions DS1 and DS2 which are different from the direction in which a centrifugal force CF0 acts on the centrifugal element 21. For example, the first and second side walls 122a are 122b are formed parallel to each other and extend in the directions DS1 and DS2 which are different from the direction in which a centrifugal force CF0 acts on the centrifugal element 21. More specifically, when the hub flange 12 is viewed from the outer side in the axial direction (the recess 122 is viewed from the outer side in the axial direction), the first and second side walls 122a and 122b are inclined relative to a straight line L connecting the center of rotation O of the hub flange 12 and a center C of the cam mechanism 22 in the circumferential direction.

Here, the direction in which the centrifugal force CF0 acts on the centrifugal element 21 is a direction in which the centrifugal force CF0 has acted on a center of gravity G1 or G2 of the centrifugal element 21. In other words, the direction in which the centrifugal force CF0 acts on the centrifugal element 21 is a radial direction in which the centrifugal force CF0 passes through the center of gravity G1 or G2 of the centrifugal element 21.

The direction DS1 or DS2 different from the direction in which the centrifugal force CF0 acts on the centrifugal element 21 corresponds to a direction (guiding direction) in which the first and second side walls 122a and 122b guide the centrifugal element 21. In other words, the direction DS1 or DS2 different from the direction in which the centrifugal force CF0 acts on the centrifugal element 21 corresponds to a direction (movement direction) in which the centrifugal element 21 moves.

The direction DS1 or DS2 different from the direction in which the centrifugal force CF0 acts on the centrifugal element 21, for example the direction (guiding direction) in which the first and second wall portions 122a and 122b extend, intersects with the direction in which the centrifugal force CF0 acts on the centrifugal element 21 (radial direction in which the centrifugal force CF0 passes through the center of gravity G1 or G2 of the centrifugal element 21). More specifically, the absolute value of the inner product of a direction vector of the direction DS1 or DS2 different from the direction in which the centrifugal force CF0 acts on the centrifugal element 21 and a vector of the direction in which the centrifugal force CF0 acts on the centrifugal element 21 is less than 1.

More specifically, as illustrated in FIG. 2, each recess 122 includes a first recess 123 and a second recess 124. The configuration of the first recess 123 and the configuration of the second recess 124 are substantially the same except for the directions in which the first and second side walls 122a and 122b are formed.

As illustrated in FIG. 6A, when the hub flange 12 is viewed from an external side in the axial direction (when the first recess 123 is viewed from the external side in the axial direction), a first and second side wall 123a of the first recess 123 on the first rotational direction R1 side is inclined with respect to the straight line L so as to approach the straight line L in the radial direction separating from the center of rotation O along the straight line L. In addition, a first and second side wall 123b of the first recess 123 on the second rotational direction R2 side is inclined with respect to the straight line L so as to separate from the straight line L in the radial direction separating from the center of rotation O along the straight line L.

On the other hand, as illustrated in FIG. 6B, when the hub flange 12 is viewed from an external side in the axial direction (when the second recess 124 is viewed from an external side in the axial direction), a first and second side wall 124a of the second recess 124 on the second rotational direction R2 side is inclined with respect to the straight line L so as to approach the straight line L in the radial direction separating from the center of rotation O along the straight line L. In addition, a first and second side wall 124b of the second recess 124 on the first rotational direction R1 side is inclined with respect to the straight line L so as to separate from the straight line L in the radial direction separating from the center of rotation O along the straight line L.

[Centrifugal Element and Support Portion]

As illustrated in FIGS. 2 to 6B, the centrifugal element 21 is disposed in the recess 122 of the hub flange 12. The centrifugal element 21 is movable in the direction DS1 or DS2 different from the direction in which the centrifugal force CF0 acts on the centrifugal element 21 due to the centrifugal force CF0 generated by the rotation of the hub flange 12.

As illustrated in FIGS. 3 and 4, the centrifugal element 21 includes first guide rollers 26a, second guide rollers 26b and pins 27 which rotatably support each guide roller 26a and 26b.

The first guide rollers 26a and the second guide rollers 26b are disposed in grooves 21a and 21b on either end of the centrifugal element 21. The guide rollers 26a and 26b each include an outer peripheral roller and an inner peripheral roller disposed on an inner circumference side of the outer peripheral roller.

The first guide roller 26a is configured to roll by abutting against the first side wall 122a (123a or 124a) of the recess 122. The second guide roller 26b is configured to roll by abutting against the second side wall 122b (123b or 124b) on the opposite side of the recess 122.

In this way, the first side wall 122a (123a or 124a ) and the second side wall 122b (123b or 124b) of the recess 122 function as support portions 23 which moveably support the centrifugal element 21 in the direction DS1 or DS2 (see FIGS. 6A and 6B) different from the direction in which the centrifugal force CF0 acts. In other words, it can be interpreted that each support portion 23 includes the first side wall 122a (123a or 124a) and the second side wall 122b (123b or 124b).

The pins 27 penetrate the groove 21a or 21b in the centrifugal element 21 in the axial direction. Both ends of each pin 27 are fixed to the centrifugal element 21.

As illustrated in FIG. 2, the centrifugal element 21 includes two first centrifugal elements 211 and two second centrifugal elements 212. In the following description, the four centrifugal elements 211 and 212 are sometimes simply referred to as “centrifugal element 21”.

The two first centrifugal elements 211 are disposed at positions opposing each other in the radial direction, that is, disposed at an 180° interval in the circumferential direction. Similarly, the two second centrifugal elements 212 are disposed at an 180° interval in the circumferential direction. The first centrifugal elements 211 and the second centrifugal elements 212 are disposed at a 90° interval in the circumferential direction.

For example, as illustrated in FIG. 6A, the first centrifugal elements 211 are disposed in the first recess 123 of the hub flange 12. The centrifugal force CF0 generated by rotation of the hub flange 12 causes the first centrifugal element 211 to be guided by the first and second side walls 123a and 123b in the direction DS1 different from the direction in which the centrifugal force CF0 acts on the centrifugal element 21.

As illustrated in FIGS. 3 and 5, an outer peripheral surface 21c of the first centrifugal element 211 has an arc shape recessed toward the inner peripheral side and functions as a cam 31 (described later). As illustrated in FIG. 4, the first centrifugal element 211 is formed extending in the circumferential direction and includes the grooves 21a and 21b at either end in the circumferential direction. The grooves 21a and 21b each have a width (interval in axial direction) larger than the thickness of the hub flange 12. The hub flanges 12 are inserted into the grooves 21a and 21b.

As illustrated in FIG. 6B, the second centrifugal element 212 is disposed in the second recess 124 of the hub flange 12. The centrifugal force CF0 generated by rotation of the hub flange 12 causes the second centrifugal element 212 to be guided by the first and second side walls 124a and 124b to the direction DS2 different from the direction in which the centrifugal force CF0 acts on the centrifugal element 21.

The configuration of the second centrifugal element 212 is substantially the same as the configuration of the first centrifugal element 211. Therefore, the configuration of the second centrifugal element 212 is described with reference to FIGS. 3 to 5 used to describe the configuration of the first centrifugal element 211. Here, components of the second centrifugal element 212 are denoted by the same reference symbols as those of the first centrifugal element 211.

The outer peripheral surface 21c of the second centrifugal element 212 has an arc shape recessed toward the inner peripheral side and functions as the cam 31 (described later). The second centrifugal element 212 is formed so as to extend in the circumferential direction and includes the grooves 21a and 21b at either end in the circumferential direction. The grooves 21a and 21b each have a width (interval in the axial direction) larger than the thickness of the hub flange 12. The hub flanges 12 are inserted into the groove 21a and 21b.

As illustrated in FIGS. 6A and 6B, the center of gravity G1 and G2 of the first centrifugal element 211 and the second centrifugal element 212 is disposed on the straight line L which connects the center of gravity G1 or G2 to the center C of the cam mechanisms 22 in the circumferential direction. Component force CF1b and CF2b in the centrifugal direction as component force of the centrifugal force CF0 acts on the cams 31 of each of the first centrifugal element 211 and the second centrifugal element 212 while the first centrifugal element 211 and the second centrifugal element 212 abut against a cam follower 30 (described later).

As illustrated in FIG. 6A, in the first centrifugal element 211, the centrifugal force CF0 is formed of radial direction component force CF1a and circumferential direction component force CF1b. As illustrated in FIG. 6B, in the second centrifugal element 212, the centrifugal force CF0 is formed of radial direction component force CF2a and circumferential direction component force CF2b. The direction of the circumferential direction component force CF1b acting on the first centrifugal element 211 is opposite to the direction of the circumferential direction component force CF2b acting on the second centrifugal element 212.

Here, more specifically, the straight line L is a straight line which connects the center of rotation O and a point of contact C (point of contact when the centrifugal element 21 is subject to the centrifugal force CF0 and the hub flange 12 and the inertia ring 20 are not rotating relative to each other) between the cam 31 and the cam follower 30. The point of contact C between the cam 31 and the cam follower 30 corresponds to the above-mentioned center C of the cam mechanism 22 in the circumferential direction.

As illustrated in FIG. 6A, when the above-described component forces CF1a and CF1b act on the first centrifugal element 211, anticlockwise turning moment CR1 acts on the first centrifugal element 211 about an axis (axis parallel to the rotational axis of the hub flange 12) including the point of contact C between the cam 31 and the cam follower 30. As a result, the first centrifugal element 211 rotates about the center C of the cam mechanism 22 in the circumferential direction (point of contact C between the cam 31 and the cam follower 30) within the range of the gap between the first centrifugal element 211 and the first and second side walls 123a and 123b.

As illustrated in FIG. 6B, when the above-described component forces CF2a and CF2b act on the second centrifugal element 212, clockwise turning moment CR2 acts on the second centrifugal element 212 about the axis (axis parallel to the rotational axis of the hub flange 12) including the point of contact C between the cam 31 and the cam follower 30. As a result, the second centrifugal element 212 rotates about the center C of the cam mechanism 22 in the circumferential direction (point of contact C between the cam 31 and the cam follower 30) within the range of the gap between the second centrifugal element 212 and the first and second side walls 124a and 124b. The rotational direction of the second centrifugal element 212 is opposite to the rotational direction of the first centrifugal element 211.

In this way, through the first and second centrifugal elements 211 and 212 turning, the first and second centrifugal elements 211 and 212 separately make contact with the first and second side walls 123a, 123b, 124a and 124b of the first and second recesses 123 and 124. In this state, the first and second centrifugal elements 211 and 212 move along the first and second side walls 123a, 123b, 124a and 124b of the first and second recesses 123 and 124.

[Cam Mechanism]

As illustrated in FIG. 3, the cam mechanism 22 is formed of the cylindrical roller 30 serving as a cam follower and the outer peripheral surface 21c of the centrifugal element 21 (first centrifugal element 211 and second centrifugal element 212) serving as a cam. The roller 30 is fitted into the outer periphery of a body portion of the rivet 203. In other words, the roller 30 is supported by the rivet 203.

Note that while the roller 30 is preferably rotatably mounted to the rivet 203, the roller 30 may be unable to rotate. The cam 31 is an arc-shaped surface which the roller 30 abuts against. When the hub flange 12 and the first and second inertia rings 201 and 202 relatively rotate within a predetermined angle range, the roller 30 moves along the cam 31.

Here, the cams 31 (outer peripheral surfaces 21c) formed in the first centrifugal element 211 and the second centrifugal element 212 have the same shape. However, as described above, the directions DS1 and DS2 in which the first centrifugal element 211 and the second centrifugal element 212 are guided by the first and second recesses 123 and 124 (first and second side walls 123a, 123b, 124a and 124b) are different from each other (see FIGS. 6A and 6B).

Therefore, the cam mechanism 22 including the cam 31 formed in the first centrifugal element 211 and the cam mechanism 22 including the cam 31 formed in the second centrifugal element 212 have different torsional characteristics. When these cam mechanisms 22 need to be distinguished herein, the former is referred to as “first cam mechanism 221” and the latter is referred to as “second cam mechanism 222”.

When contact between the roller 30 and the cam 31 generates a rotational phase difference between the hub flange 12 and the first and second inertia rings 201 and 202, the centrifugal force CF0 generated in the centrifugal element 21 (first centrifugal element 211 or second centrifugal element 212) is converted to force in a circumferential direction which decreases the rotational phase difference. Details of this are described later.

[Operation of Cam Mechanism]

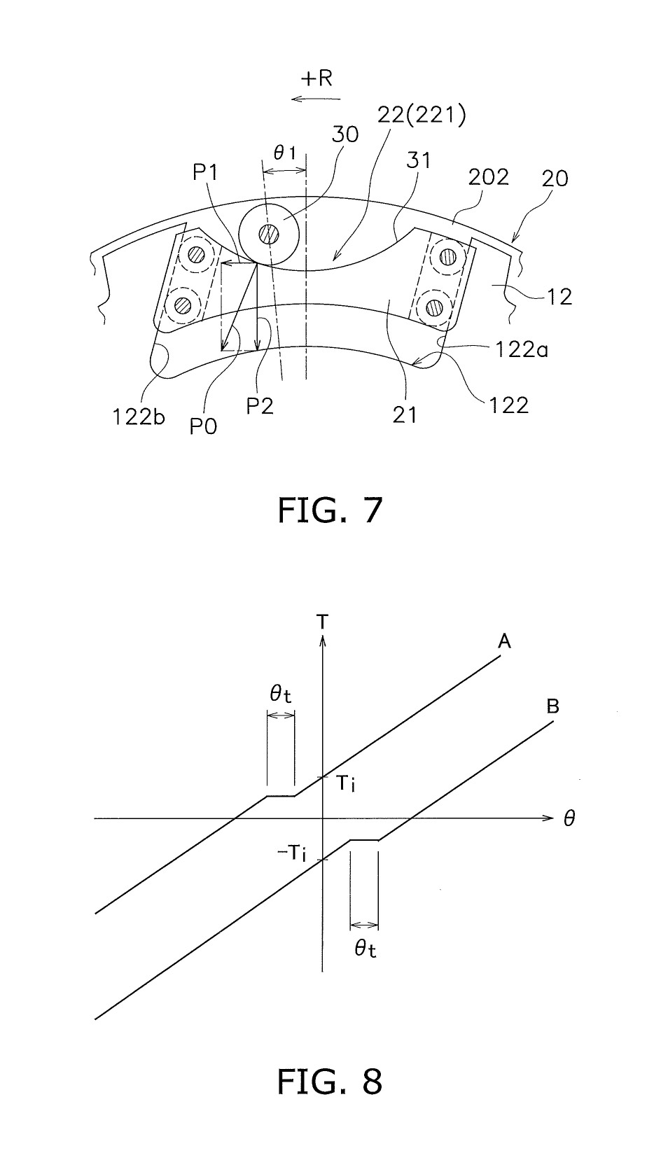

Operation of the cam mechanism 22 (inhibition of torque fluctuation) is described with reference to FIGS. 3 and 7. Note that, in the following description, the first and second inertia rings 201 and 202 are also simply referred to as “inertia ring 20”.

When lock-up is on, the torque transmitted to the front cover 2 is transmitted to the hub flange 12 via the input-side rotational body 11 and the damper 13.

If there is no torque fluctuation when torque is transmitted, the hub flange 12 and the inertia ring 20 rotate as illustrated in FIG. 3. In this state, the roller 30 of the cam mechanism 22 abuts against a position on the innermost circumference side of the cam 31 (central position in the circumferential direction) and the rotational phase difference between the hub flange 12 and the inertia ring 20 is “0”.

As described above, the amount of phase displacement in the rotational direction between the hub flange 12 and the inertia ring 20 is referred to as “rotational phase difference”, but in FIGS. 3 and 6, the amount of phase displacement is represented as deviation between center positions in the circumferential direction of the centrifugal 21 (first centrifugal element 211) and the cam 31 and the center position of the roller 30.

Here, if there is torque fluctuation when torque is transmitted, as illustrated in FIG. 7, a rotational phase difference θ occurs between the hub flange 12 and the inertia ring 20. FIG. 7 illustrates a case in which there is a rotational phase difference of +θ1 (for example,) 5° on a +R side.

As illustrated in FIG. 7, when a rotational phase difference of +θ1 has occurred between the hub flange 12 and the inertia ring 20, the roller 30 of the cam mechanism 22 relatively moves to the left in FIG. 7 along the cam 31. At this time, because the centrifugal force CF0 acts on the centrifugal element 21, the reaction force applied from the roller 30 to the cam 31 formed in the centrifugal element 21 has the direction and magnitude of P0 in FIG. 7. This reaction force P0 generates first component force P1 in the circumferential direction and second component force P2 in the direction in which the centrifugal element 21 is moved along an inner peripheral side.

Then, the first component force P1 becomes force which moves the hub flange 12 toward the left in FIG. 7 via the cam mechanism 22 and the centrifugal element 21. In other words, force in the direction in which the rotational phase difference between the hub flange 12 and the inertia ring 20 reduces acts on the hub flange 12. Further, the second component force P2 causes the centrifugal element 21 to move toward the inner periphery against the centrifugal force CF0.

Note that, when a rotational phase difference occurs in the opposite direction, the roller 30 relatively moves to the right in FIG. 7 along the cam 31. The operation principle in both these cases is the same. Further, FIG. 7 illustrates a case in which the first centrifugal element 211 is used, but the operation principle is the same for the second centrifugal element 212 even though the directions of the component forces P1 and P2 are opposite directions.

As described above, when a rotational phase difference occurs between the hub flange 12 and the inertia ring 20 due to torque fluctuation, the hub flange 12 is subject to force (first component force P1) in the direction in which the rotational phase difference between these components reduces due to the centrifugal force CF0 acting on the centrifugal element 21 (first centrifugal element 211 and second centrifugal element 212) and the operation of the cam mechanism 22. This force inhibits torque fluctuation.

The force which inhibits torque fluctuation varies depending on the centrifugal force CF0, that is, the rotational speed of the hub flange 12, and also varies depending on the rotational phase difference and the shape of the cam 31. Therefore, the characteristics of the torque fluctuation inhibiting device 14 can be set to optimal characteristics according to engine specifications and the like by appropriately setting the shape of the cam 31.

For example, the shape of the cam 31 can be set to a shape with which the first component force P1 changes to a linear shape according to the rotational phase difference under a state where the same centrifugal force CF0 acts. In addition, the shape of the cam 31 can be set to a shape with which the first component force P1 changes to a nonlinear shape according to the rotational phase difference.

Here, a small gap for allowing the centrifugal element 21 to move smoothly is secured between the centrifugal element 21 (first centrifugal element 211 and second centrifugal element 212) and the first and second side wall 122a (123a and 124a) and 122b (123b and 124b) of the recess 122 (first recess 123 and second recess 124).

In contrast, as illustrated in FIGS. 6A and 6B, when the centrifugal force CF0 acts on the centrifugal element 21, turning moments CR1 and CR2 in the opposite direction act on the first centrifugal element 211 and the second centrifugal element 212, respectively.

More specifically, as illustrated in FIG. 6A, because the direction of the centrifugal force CF0 acting on the first centrifugal element 211 is different from the direction DS1 in which the first centrifugal element 211 moves, in the first centrifugal element 211, the above-mentioned component forces CF1a and CF1b are generated in both the direction DS1 in which the first centrifugal element 211 moves and a direction orthogonal to the direction DS1.

Then, the anticlockwise turning moment CR1 acts on the first centrifugal element 211 about the axis (axis parallel to the rotational axis of the hub flange) including the point of contact C between the cam 31 and the cam follower 30. As a result, the orientation of the first centrifugal element 211 changes, the outer peripheral roller of the first guide roller 26a abuts against the first side wall 122a of the recess 122 and the inner peripheral roller of the second guide roller 26b abuts against the second side wall 122b of the recess 122.

As described above, through the turning moment CR1 acting on the first centrifugal element 211, the orientation of the first centrifugal element 211 stabilizes relative to the first and second side walls 122a (123a) and 122b (123b) of the recess 122 (first recess 123).

As illustrated in FIG. 6B, when the centrifugal force CF0 acts on the second centrifugal element 212, turning moment CR2 in the direction opposite to the first centrifugal element 211 acts on the second centrifugal element 212. Then, similar to the first centrifugal element 211, the orientation of the second centrifugal element 212 changes and the first guide roller 26a and the second guide roller 26b separately abut against the first side wall 122a and the second side wall 122b of the recess 122, respectively. As a result, the orientation of the second centrifugal element 212 stabilizes relative to the first and second side walls 122a (124a) and 122b (124b) of the recess 122 (second recess 124).

[Torsional Characteristics of Torque Fluctuation Inhibiting Device]

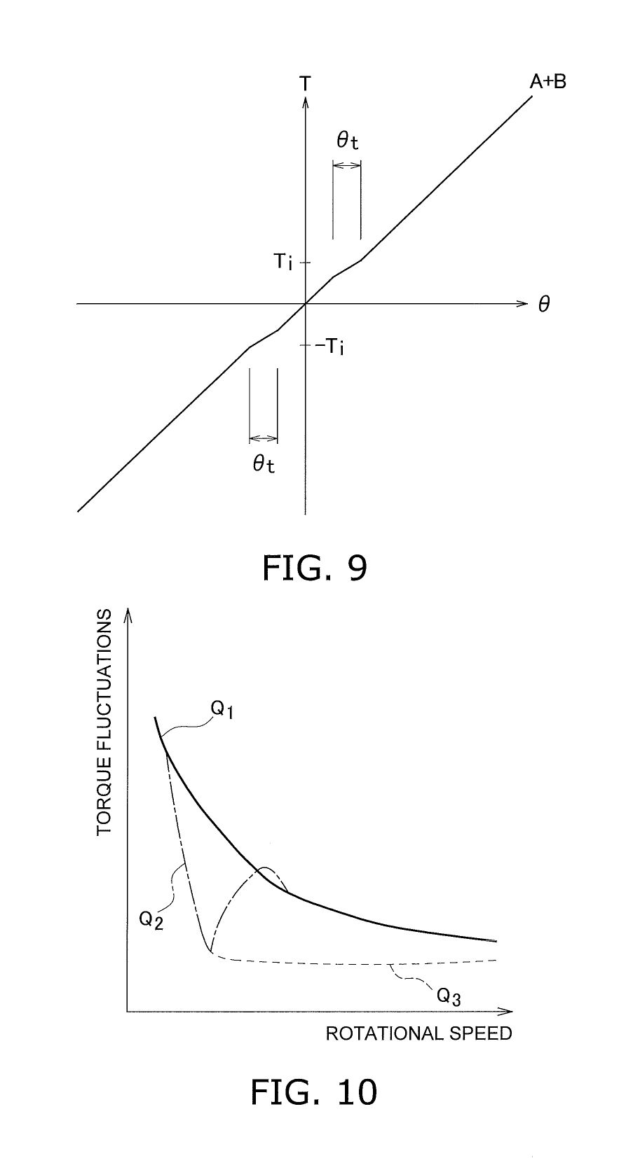

The torque fluctuation inhibiting device 14 with the above-described configuration has the torsional characteristics illustrated in FIGS. 8 and 9. In FIG. 8, the characteristic A is a torsional characteristic resulting from the first cam mechanism 221 and the characteristic B is a torsional characteristic resulting from the second cam mechanism 222.

In FIGS. 8 and 9, the horizontal axis represents the rotational phase difference between the hub flange 12 and the inertia ring 20 (torsional angle θ of both components). The vertical axis represents a torque T (corresponding to the circumferential direction component force P1 in FIG. 7) for inhibiting torque fluctuation with the first and second cam mechanisms 221 and 222.

As described above, there is a gap between the first and second centrifugal element 211 or 212 and the recess 122 and the first and second centrifugal element 211 or 212 moves in the direction DS1 or DS2 different from the direction in which the centrifugal force CF0 acts.

Because of this, even if there is no rotational phase difference between the hub flange 12 and the inertia ring 20, the turning moments CR1 and CR2 act on the first and second centrifugal elements 211 and 212 and the orientations of the first and second centrifugal elements 211 and 212 incline when the centrifugal force CF0 acts on the first and second centrifugal elements 211 and 212. Here, the turning moment CR1 that acts on the first centrifugal element 211 is generated by the component forces CF1a and CF1b of the centrifugal force CF0. The turning moment CR2 that acts on the second centrifugal element 212 is generated by the component forces CF2a and CF2b of the centrifugal force CF0.

In other words, because the shape of the cam 31 formed on the outer peripheral surfaces of the first and second centrifugal elements 211 and 212 inclines, initial torque Ti is generated even if the torsional angle θ is “0”. (see FIG. 8). Because the turning moments CR1 and CR2 that act on the first centrifugal element 211 and the second centrifugal element 212, respectively, are opposite to each other, the initial torque Ti with the torsional characteristics A due to the first cam mechanism 221 and the initial torque −Ti with the torsional characteristics B due to the second cam mechanism 222 have opposite polarities.

Here, as illustrated in FIGS. 6A and 8, if the torsional angle θ in the first centrifugal element 211 increases in a positive direction (R1 direction) and, for example, the point of contact C between the cam 31 and the cam follower 30 moves from the straight line L toward the R1 side, torque T for inhibiting torque fluctuation also increases as a result.

On the other hand, if the torsional angle θ increases in a negative direction (R2 direction) and the point of contact C between the cam 31 and the cam follower 30 moves from the straight line L to the R2 side, the component force CF1b of the centrifugal force CF0 gradually reduces.

When the component force CF1b of the centrifugal force CF0 becomes zero and the point of contact C between the cam 31 and the cam follower 30 moves further from the straight line L toward the R2 side, the first centrifugal element 211 rotates in the opposite direction and the orientation of the first centrifugal element 211 changes. At this time, in a section (section θt in FIG. 8) where a rotational phase difference is present, torque does not substantially change. In addition, after the orientation of the first centrifugal element 211 has changed, the torque T for inhibiting torque fluctuation increases as a result of the torsional angle θ increasing in the negative direction.

As illustrated in FIGS. 6B and 8, the second centrifugal element 212 also undergoes an orientation change similar to that of the first centrifugal element 211. The turning moment CR2 acting on the second centrifugal element 212 is opposite to the turning moment CR1 acting on the first centrifugal element 211, and hence the section (section θt in FIG. 8) where a rotational phase difference is present is formed on a side opposite to the first centrifugal element 211 from the vertical axis.

In FIG. 8, the torsional characteristic A of the first cam mechanism 221 and the torsional characteristic B of the second cam mechanism 222 are shown separately. However, in this embodiment, the same number of first cam mechanisms 221 and second cam mechanisms 222 are provided. In addition, the first cam mechanism 221 and the second cam mechanism 222 are arranged symmetrically with respect to the center of rotation O. Further, the first cam mechanism 221 and the second cam mechanism 222 are alternately arranged in the circumferential direction.

Therefore, the torsional characteristics A+B of the entire device are, as illustrated in FIG. 9, a combination of the torsional characteristic A and the torsional characteristic B in FIG. 8. In the characteristics in FIG. 9, the initial torque of the first centrifugal element 211 and the second centrifugal element 212 cancel each other out and the initial torque becomes “0”.

On positive and negative sides of the torsional characteristics A+B, in the above-mentioned section θt, the inclination of the characteristics A+B, for example, the torque T changes for inhibiting torque fluctuation with the first and second cam mechanisms 221 and 222 against the torsional angle θ between the hub flange 12 and the inertia ring 20.

However, in conventional technology, the orientation of the centrifugal element 21 may constantly fluctuate while the torque fluctuation inhibiting device 14 is operating. In contrast, with the structure according to the present advancement, the orientation of the centrifugal element 21 is stable. As a result, hysteresis in the torsional characteristics of the torque fluctuation inhibiting device 14 can be eliminated. Similarly, because the orientation of the centrifugal element 21 is stable during operation, desired characteristics can be obtained.

In this way, because the orientation of the centrifugal element 21 is stable while the centrifugal element 21 operates, hysteresis in the torsional characteristics of the torque fluctuation inhibiting device 14 can be eliminated. Similarly, because the orientation of the centrifugal element 21 is stable during operation, desired characteristics can be obtained.

[Examples of Features]

FIG. 10 is a diagram for showing an example of torque fluctuation inhibition characteristics. In FIG. 10, the horizontal axis represents rotational speed and the vertical axis represents torque fluctuation (rotational speed fluctuation). The characteristic Q1 represents a case where a device for inhibiting torque fluctuation is not provided, the characteristic Q2 represents a case where a conventional dynamic damper device that does not have a cam mechanism is provided, and the characteristic Q3 represents a case where the torque fluctuation inhibiting device 14 according to this embodiment is provided.

As is evident from FIG. 10, with the device provided with the dynamic damper device that does not have a cam mechanism (characteristic Q2), torque fluctuation can only be inhibited within a specific rotational speed range. In contrast, with the present embodiment including the cam mechanism 22 (characteristic Q3), torque fluctuation can be inhibited within all rotational speed ranges.

### Second Embodiment

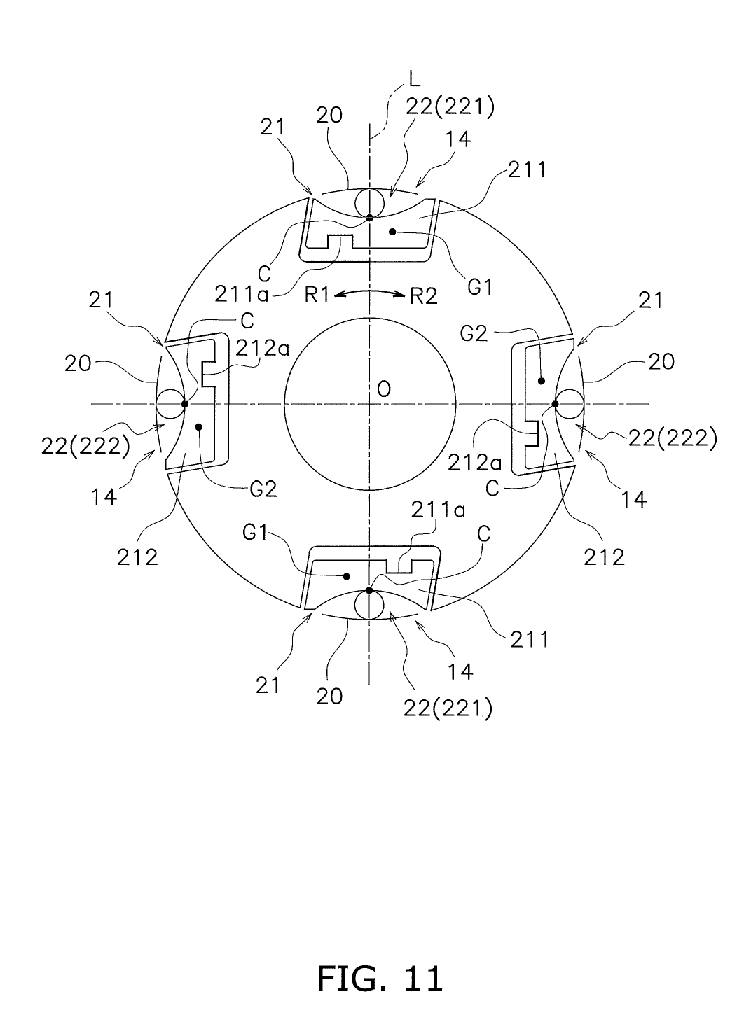

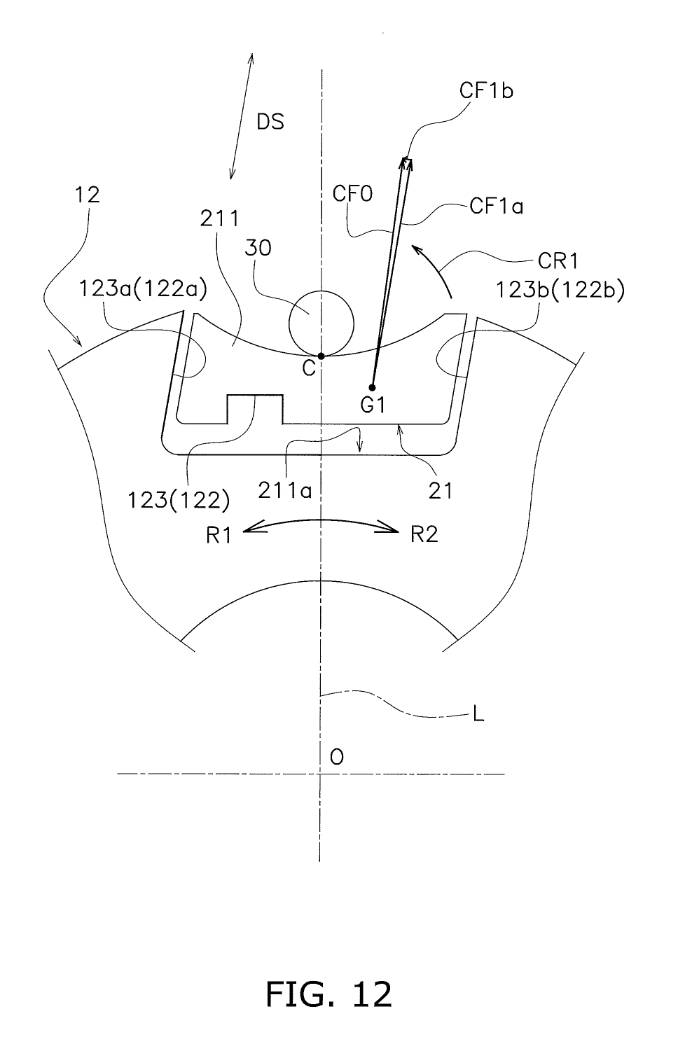

In the first embodiment, there is described an example where the centers of gravity G1 and G2 of the first centrifugal element 211 and the second centrifugal element 212 are arranged on the straight line L connecting the centers of gravity G1 and G2 and the center C of the cam mechanisms 22 in the circumferential direction. As illustrated in FIGS. 11 and 12, the second embodiment differs from the first embodiment in that the centers of gravity G1 and G2 of the first centrifugal element 211 and the second centrifugal element 212 deviate from the straight line L connecting the centers of gravity G1 and G2 and the center C of the cam mechanisms 22 in the circumferential direction.

Excluding this difference, the configuration of the second embodiment is substantially the same as that of the first embodiment. Therefore, in the second embodiment, configurations different from the first embodiment are described and descriptions of other configurations are omitted. Any omitted descriptions herein are equivalent to the corresponding descriptions of the first embodiment.

The center of gravity G1 of the first centrifugal element 211 deviates from the straight line L. The center of gravity G1 of the first centrifugal element 211 is a center of gravity on the second rotational direction R2 side from the straight line L. With this configuration, the orientation of the first centrifugal element 211 inclines due to the turning moment CR1 which occurs due to deviation of the center of gravity G1.

Similar to the first embodiment, the turning moment CR1 acts on the first centrifugal element 211 about the point of contact C between the cam 31 and the cam follower 30 due to the component forces CF1a and CF1b in the centrifugal force CF0 acting on the center of gravity G1 of the first centrifugal element 211.

Here, the first centrifugal element 211 is asymmetrically formed with respect to the straight line L. For example, a notch portion 211a is formed in the first centrifugal element 211 and the first centrifugal element 211 is asymmetrically formed with respect to the straight line L.

The thickness of the first centrifugal element 211 is substantially constant in the radial direction and the circumferential direction. When the torque fluctuation inhibiting device 14 is viewed externally in the axial direction (when the first centrifugal element 211 is viewed externally in the axial direction), the area of a portion of the first centrifugal element 211 on the R2 side is larger than the area of a portion of the first centrifugal element 211 on the R1 side. Due to this, the center of gravity G1 of the first centrifugal element 211 is disposed at a position which deviates from the circumferential direction center C toward the rotational direction R2 side.

The portion of the first centrifugal element 211 on the R1 side corresponds to a portion of the first centrifugal element 211 disposed between the straight line L and the first side wall 123a on the R1 side of the recess 122. The portion of the first centrifugal element 211 on the R2 side corresponds to a portion of the first centrifugal element 211 disposed between the straight line L and the second side wall 123b on the R2 side of the recess 122.

Note that the portion of the first centrifugal element 211 on the R1 side may be thicker than the portion of the first centrifugal element 211 on the R2 side. In this case, the area of the portion of the first centrifugal element 211 on the R1 side may be the same as the area of the portion of the first centrifugal element 211 on the R2 side.

The second centrifugal element 212 has substantially the same configuration as that of the first centrifugal element 211, and hence only configurations of the second centrifugal element 212 different from the first centrifugal element 211 are described.

The center of gravity G2 of the second centrifugal element 212 deviates from the straight line L. The center of gravity G2 of the second centrifugal element 212 has a center of gravity on the first rotational direction R1 side with respect to the straight line L. With this configuration, the orientation of the second centrifugal element 212 inclines due to the component forces CF2a and CF2b of the centrifugal force CF0 acting on the center of gravity G2 of the second centrifugal element 212.

Similar to the first embodiment, the turning moment CR2 acts on the second centrifugal element 212 about the point of contact C between the cam 31 and the cam follower 30 due to the component forces CF2a and CF2b in the centrifugal force CF0 acting on the center of gravity G2 of the second centrifugal element 212.

Here, similar to the first centrifugal element 211, the second centrifugal element 212 is asymmetrically formed with respect to the straight line L. For example, a notch portion 212a is formed in the second centrifugal element 212 and the second centrifugal element 212 is asymmetrically formed with respect to the straight line L.

The thickness of the second centrifugal element 212 is substantially constant in the radial direction and the circumferential direction. When the torque fluctuation inhibiting device 14 is viewed externally in the axial direction (when the second centrifugal element 212 is viewed externally in the axial direction), the area of a portion of the second centrifugal element 212 on the R1 side is larger than the area of a portion of the second centrifugal element 212 on the R2 side. Due to this, the center of gravity G2 of the second centrifugal element 212 is disposed at a position which deviates from the circumferential direction center C toward the rotational direction R1 side.

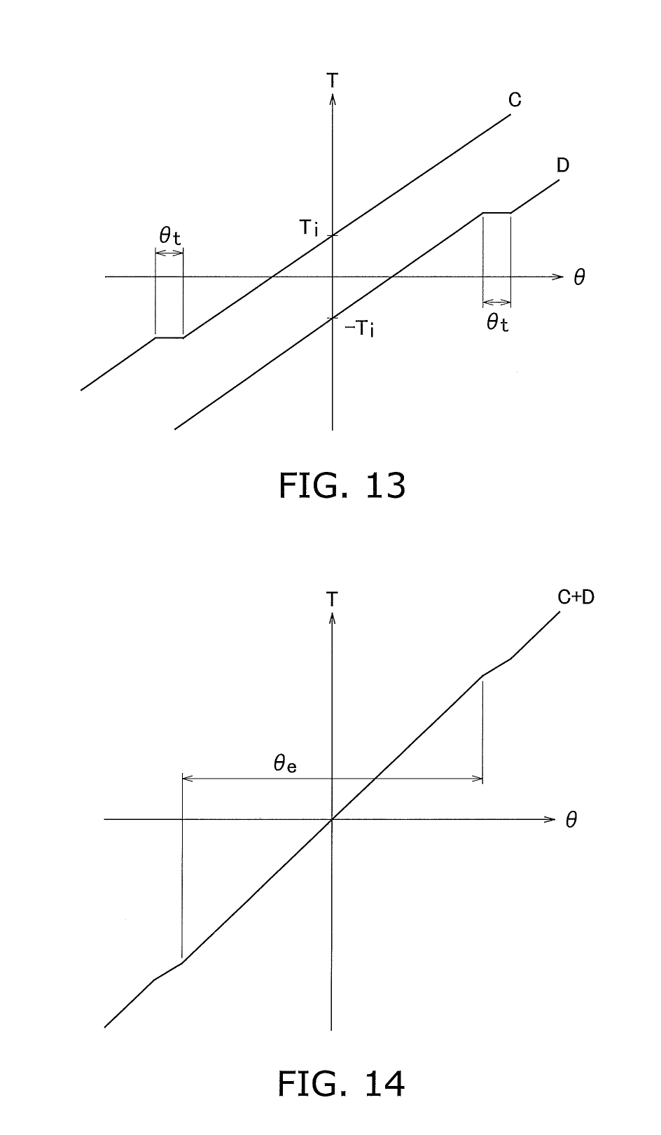

When the first centrifugal element 211 and the second centrifugal element 212 are configured as described above, the torsional characteristics of the torque fluctuation inhibiting device 14 correspond to those shown in FIGS. 13 and 14.

The characteristic C is a torsional characteristic resulting from the first cam mechanism 221 and the characteristic D is a torsional characteristic resulting from the second cam mechanism 222.

In FIGS. 13 and 14, the horizontal axis represents a rotational phase difference between the hub flange 12 and the inertia ring 20 (the torsional angle θ of both components) and the vertical axis represents the torque T for inhibiting torque fluctuation using the first and second cam mechanisms 221 and 222 (corresponding to circumferential direction component force P1 in FIG. 7).

As described above, there is a gap between the first and second centrifugal element 211 or 212 and the recess 122. In addition, the first and second centrifugal element 211 or 222 moves in the direction DS1 or DS2 (see FIGS. 6A and 6B) different from the direction in which the centrifugal force CF0 acts. In addition, the first and second centrifugal element 211 or 222 has a deviated center of gravity G1 or G2.

Because of this, if there is no rotational phase difference between the hub flange 12 and the inertia ring 20 when the centrifugal force CF0 acts on the first and second centrifugal elements 211 and 212, the orientation of the first centrifugal element 211 and the orientation of the second centrifugal element 212 incline as described above.

In this case, because the shape of the cam 31 formed on the outer peripheral surface of the first and second centrifugal elements 211 and 212 inclines, the initial torque Ti is generated even if the torsional angle θ is “0”.

Because the turning moments CR1 and CR2 that act on the first centrifugal element 211 and the second centrifugal element 212, respectively, are opposite to each other, the initial torque Ti having the torsional characteristic C resulting from the first cam mechanism 221 and the initial torque −Ti having the torsional characteristic D resulting from the second cam mechanism 222 have opposite directions.

Here, for example, if the point of contact C between the cam 31 and the cam follower 30 approaches the center of gravity G1 of the first centrifugal element 211 toward the R2 side from the straight line L, the circumferential direction component force which is the component force of the centrifugal force CF0 gradually reduces if the point of contact C passes over an action line of the centrifugal force CF0. Further, if the circumferential direction component force as the component force of the centrifugal force CF0 becomes zero, the first centrifugal element 211 inclines in the opposite direction.

The second centrifugal element 212 also undergoes an orientation change similar to that of the first centrifugal element 211. The turning moment that acts on the second centrifugal element 212 is opposite to the turning moment that acts on the first centrifugal element 211, and hence the section (section θt in FIG. 13) where a rotational phase difference is present is formed on a side opposite to the first centrifugal element 211 with respect to the vertical axis.

In FIG. 13, the torsional characteristic C of the first cam mechanism 221 and the torsional characteristic D of the second cam mechanism 222 are shown separately. However, in this embodiment, the same number of first cam mechanisms 221 and second cam mechanisms 222 are provided. In addition, the first cam mechanism 221 and the second cam mechanism 222 are arranged symmetrically with respect to the center of rotation O. Further, the first cam mechanism 221 and the second cam mechanism 222 are alternately arranged in the circumferential direction.

Therefore, as illustrated in FIG. 14, the torsional characteristics C+D of the entire device are a combination of the torsional characteristic C and the torsional characteristic D in FIG. 13. With the characteristics in FIG. 14, the initial torque of the first centrifugal element 211 and the second centrifugal element 212 cancel each other out and the initial torque becomes “0”.

Note that, in torsional angle ranges (θe in FIG. 14) on positive and negative sides of the combined torsional characteristics C+D, suitable torsional characteristics can be obtained by operating the first and second cam mechanisms 221 and 222.

In addition, because the first and second centrifugal elements 211 and 212 is moved in the direction DS1 or DS2 different from the direction in which the centrifugal force CF0 acts, the section θt where torque does not fluctuate is not likely to be generated unless the component forces CF1b and CF2b of the centrifugal force CF0 exist, even if the first and second centrifugal elements 211 and 212 pass through the center of gravity G1 and G2 (even if the point of contact C passes over an action line of the centrifugal force CF0).

In other words, the section θt is generated after the point of contact C has passed over the action line of the centrifugal force CF0 and an action line of the component forces CF1a and CF2a of the centrifugal force CF0. With this configuration, the suitable torsional angle range θe can be expanded by moving the first and second centrifugal element 211 or 222 in the direction DS1 or DS2 different from the direction in which the centrifugal force CF0 acts.

In this way, because the orientation of the centrifugal element 21 is stable while the centrifugal element 21 operates, hysteresis in the torsional characteristics of the torque fluctuation inhibiting device 14 can be eliminated. Similarly, because the orientation of the centrifugal element 21 is stable during operation, desired characteristics can be obtained.

### Modification Examples

Various arrangements can be adopted if applying the above-described torque fluctuation inhibiting device 14 to the torque converter 1 or another power transmission device. Specific examples of applying the torque fluctuation inhibiting device 14 to the torque converter 1 or another power transmission device are described below with reference to schematic diagrams.

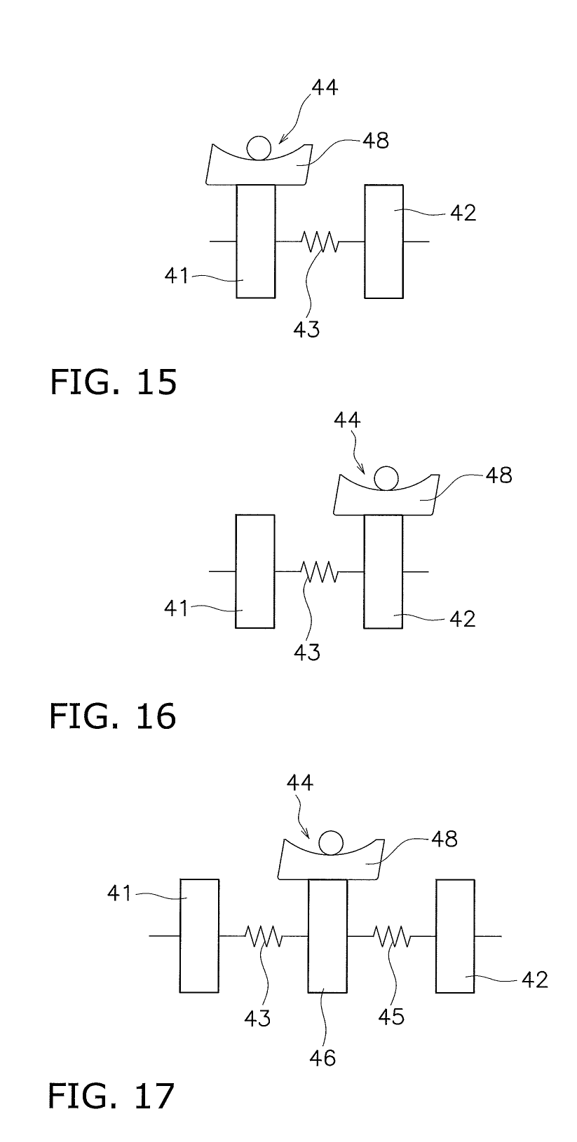

(A) FIG. 15 is a diagram for schematically illustrating a torque converter including an input-side rotational body 41, a hub flange 42 and a damper 43 provided between the two components 41 and 42. The input-side rotational body 41 includes members such as a front cover, a drive plate and a piston. The hub flange 42 includes a driven plate and a turbine hub. The damper 43 includes a plurality of torsion springs.

In the example illustrated in FIG. 15, a centrifugal element 48 is provided in any rotating member forming the input-side rotational body 41 and a cam mechanism and support portion 44 which operates using the centrifugal force CF0 acting on the centrifugal element 48 is provided. The cam mechanism and support portion 44 may have the same configuration as the configuration described in the embodiments above.

(B) In the torque converter illustrated in FIG. 16, the centrifugal element 48 is provided for any rotating member forming the hub flange 42 and the cam mechanism and support portion 44 which operates using the centrifugal force CF0 acting on the centrifugal element 48 is provided. The cam mechanism and support portion 44 may have the same configuration as the configuration described in the embodiments above.

(C) The torque converter illustrated in FIG. 17 has the configuration illustrated in FIGS. 15 and 16, and also includes a separate damper 45 and an intermediate member 46 provided between the two dampers 43 and 45. The intermediate member 46 can rotate relative to the input-side rotational body 41 and the hub flange 42 and operates the two dampers 43 and 45 in series.

In the example illustrated in FIG. 17, the intermediate member 46 is provided with the centrifugal element 48 and the cam mechanism and support portion 44 which operates using the centrifugal force CF0 acting on the centrifugal element 48 is provided. The cam mechanism and support portion 44 may have the same configuration as the configuration described in the embodiments above.

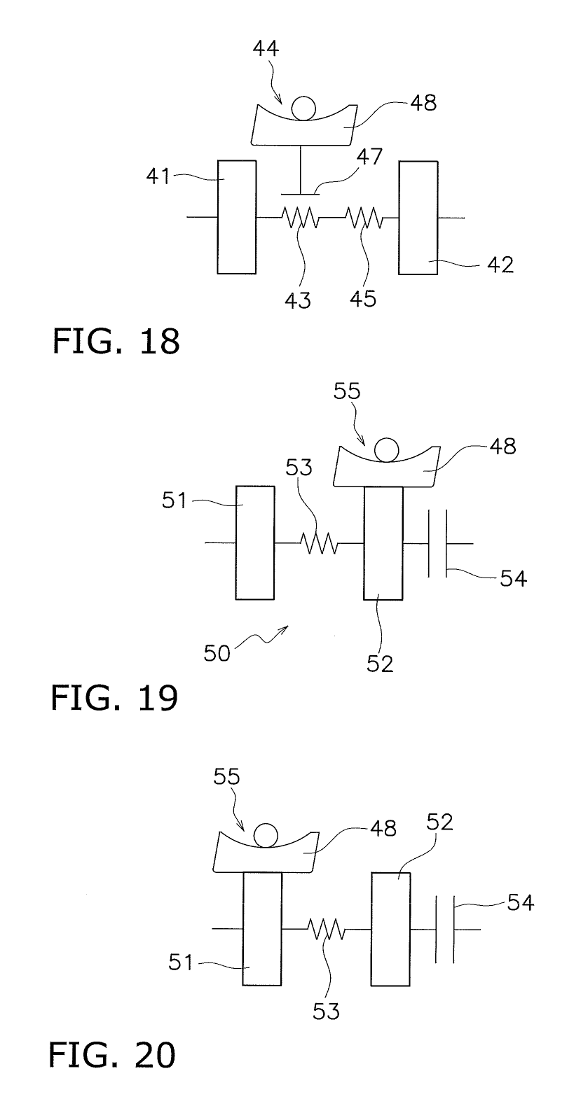

(D) The torque converter illustrated in FIG. 18 includes a floating member 47. The floating member 47 is a member used for supporting a torsion spring which forms the damper 43. The floating member 47 is, for example, formed into an annular shape and is disposed so as to cover the outer periphery and at least one side surface of the torsion spring.

The floating member 47 can rotate relative to the input-side rotational body 41 and the hub flange 42 and rotates together with the damper 43 due to friction between the torsion spring in the damper 43. In other words, the floating member 47 also rotates.

In the example illustrated in FIG. 18, the floating member 47 is provided with the centrifugal element 48, and the cam mechanism and support portion 44 which operates using the centrifugal force CF0 acting on the centrifugal element 48 is provided. The cam mechanism and support portion 44 may have the same configuration as the configuration described in the embodiments above.

(E) FIG. 19 is a schematic diagram for illustrating a power transmission device including a flywheel 50 having two inertial bodies 51 and 52 and a clutch device 54. In other words, the flywheel 50 is disposed between an engine and the clutch device 54 and includes the first inertial body 51, the second inertial body 52 disposed so as to rotate relative to the first inertial body 51 and a damper 53 disposed between the two inertial bodies 51 and 52. Note that the second inertial body 52 includes a clutch cover which forms the clutch device 54.

In the example illustrated in FIG. 19, the centrifugal element 48 is provided in any rotating member which forms the second inertial body 52 and the cam mechanism and support portion 44 which operates using the centrifugal force CF0 acting on the centrifugal element 48 is provided. The cam mechanism and support portion 44 may have the same configuration as the configuration described in the embodiments above.

(6) FIG. 20 shows an example in which, in a power transmission device similar to that in FIG. 19, the first inertial body 51 is provided with the centrifugal element 48. The cam mechanism and support portion 44 which operates using the centrifugal force CF0 acting on the centrifugal element 48 is also provided. The cam mechanism and support portion 44 may have the same configuration as the configuration described in the embodiments above.

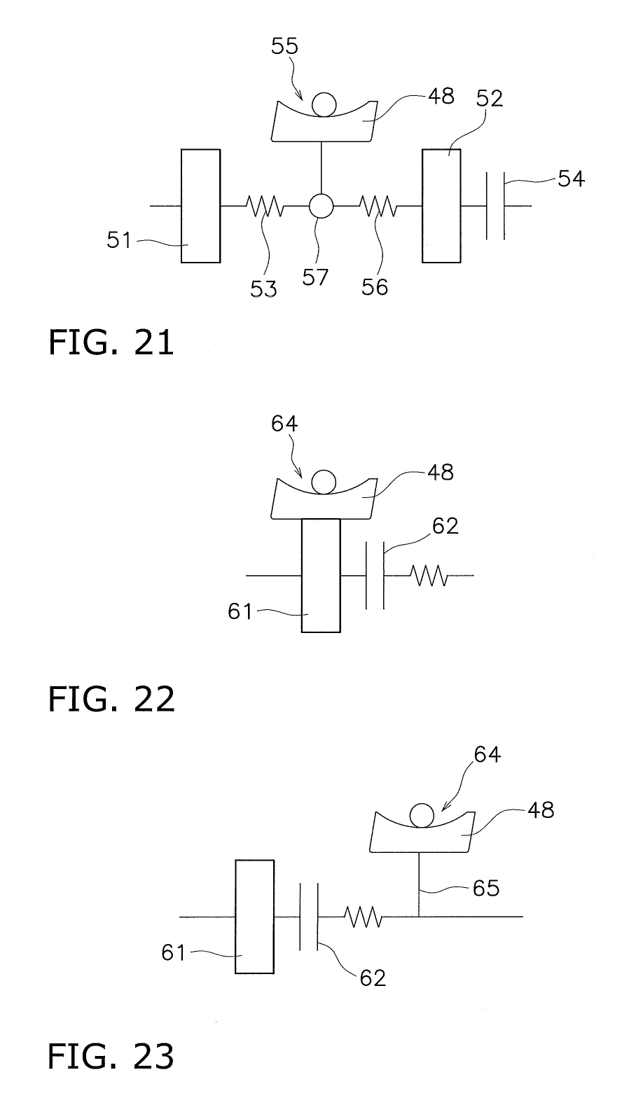

(7) The power transmission device illustrated in FIG. 21 has the configuration illustrated in FIGS. 19 and 20, and also includes a separate damper 56 and the intermediate member 57 provided between the two dampers 53 and 56. The intermediate member 57 can rotate relative to the first inertial body 51 and the second inertial body 52.

In the example illustrated in FIG. 21, the intermediate member 57 is provided with the centrifugal element 48, and the cam mechanism and support portion 44 which operates using the centrifugal force CF0 acting on the centrifugal element 48 is provided. The cam mechanism and support portion 44 may have the same configuration as the configuration described in the embodiments above.

(8) FIG. 22 is a schematic diagram for illustrating a power transmission device in which one flywheel is provided with a clutch device. The first inertial body 61 in FIG. 22 includes one flywheel and a clutch cover for the clutch device 62. In this example, the centrifugal element 48 is provided in any rotating member forming the first inertial body 61 and the cam mechanism and support portion 44 which operates using the centrifugal force CF0 acting on the centrifugal element 48 is provided. The cam mechanism and support portion 44 may have the same configuration as the configuration described in the embodiments above.

(9) FIG. 23 illustrates an example in which, in the same power transmission device as that in FIG. 22, the centrifugal element 48 is disposed on an output side of the clutch device 62. In addition, the cam mechanism and support portion 44 which operates using the centrifugal force CF0 acting on the centrifugal element 48 is provided. The cam mechanism and support portion 44 may have the same configuration as the configuration described in the embodiments above.

### Other Embodiments

The present disclosure is not limited to the above-described embodiments and may be altered or improved in various ways without departing from the scope of the present advancement.

(a) In the first and second embodiments, there is described an example in which the torque fluctuation inhibiting device 14 is mounted to a lock-up device in a torque converter, but the torque fluctuation inhibiting device 14 may be disposed in any rotating member forming a transmission, or may be disposed in a shaft (propeller shaft or drive shaft) on an output side of a transmission.

(b) In the first and second embodiments, there is described an example in which the torque fluctuation inhibiting device 14 is mounted to a lock-up device in a torque converter, but the torque fluctuation inhibiting device 14 may be applied to a conventional power transmission device provided with a known dynamic damper device or a pendulum damper device.

(c) In the first and second embodiments, there is described an example in which the centrifugal element 21 is provided in the hub flange 12, but the centrifugal element 21 may be provided in the inertia ring 20.

(d) In the first and second embodiments, there is described an example in which the first and second guide rollers 26a and 26b include an outer peripheral roller and an inner peripheral roller, but the guide rollers may be configured of only one roller. Alternatively, one roller may be provided on each side of the centrifugal element 21 in the circumferential direction, one roller may be provided between the inner peripheral surface of the centrifugal element 21 and the bottom surface of the recess, or three rollers may be used to form the guide rollers.

(e) In the first and second embodiments, there is described an example in which the first and second guide rollers 26a and 26b are used. However, for example, roller bearings may be used as the guide rollers. In this case, friction between the centrifugal element or the recess of the hub flange and the outer periphery of the roller bearing can be further reduced.

(f) In the first and second embodiments, there is described an example in which each support portion 23 includes the first and second side walls 122a and 122b and the centrifugal element 21 includes the first and second guide rollers 26a and 26b. Alternatively, the centrifugal element 21 may be formed of a body portion in which each support portion 23 includes the first and second side walls 122a and 122b and the first and second guide rollers 26a and 26b and the centrifugal element 21 does not include the first and second guide rollers 26a and 26b. In this case, the body portion of the centrifugal element 21 is guided by making contact with the first and second guide rollers 26a and 26b provided on the first and second side walls 122a and 122b.

(g) In the first and second embodiments, the first and second guide rollers 26a and 26b are disposed in the support portion 23, but another member configured to reduce friction, such as resin lace or a resin sheet, may be provided in place of the first and second guide rollers 26a and 26b. In this case, the member configured to reduce friction is pushed against the centrifugal element 21 or the recess 122 of the hub flange 12 by a biasing member.

(h) In the first and second embodiments, there is described an example in which the first centrifugal element 211 and the second centrifugal element 212 are used as centrifugal elements 21, but either a plurality of first centrifugal elements 211 or a plurality of second centrifugal elements 212 may be used. In this case, although initial torque cannot be made “0”, the orientation of the centrifugal element 21 can be stably held and hysteresis in the torsional characteristics of the torque fluctuation inhibiting device 14 can be eliminated.

(i) In the second embodiment, there is described an example in which the centrifugal element 21 is asymmetrically formed, but the centrifugal element 21 may have a symmetrical shape provided that the centrifugal element 21 is movable in the direction DS1 or DS2 different from the direction in which the centrifugal force CF0 acts.

In this case, for example, the center of gravity G1 or G2 of the centrifugal element 21 can be biased by providing the centrifugal element 21 with a weighted portion (not shown) based on the straight line L. In addition, one side of the centrifugal element 21 may be provided with a thick portion that is thicker than other portions and that portion may be the weighted portion. Further, a member (weighted member) made of a material having a larger specific gravity than other portions may be embedded and fixed on one side of the centrifugal element.

### REFERENCE SYMBOLS LIST

1 Torque converter
11 Input-side rotational body
12, 42 Hub flange (rotating body)
122 Recess
122a First side wall (support portion)
122b Second side wall (support portion)
14 Torque fluctuation inhibiting device
20, 201, 202 Inertia ring (mass body)
21, 58, 65 Centrifugal element
211 First centrifugal element
212 Second centrifugal element
22 Cam mechanism
23 Support portion
26a, 26b Guide roller
30 Roller (cam follower)
31 Cam
41 Input-side rotational body
43 Damper
50 Flywheel
51, 61 First inertial body
52 Second inertial body
54, 62 Clutch device

What is claimed is:

1. A torque fluctuation inhibiting device configured to inhibit torque fluctuation, the torque fluctuation inhibiting device comprising:
a first rotating body to which torque is input;
a second rotating body rotatably disposed relative to the first rotating body;
a centrifugal element which is subject to centrifugal force due to rotation of the first rotating body and which is configured to move in a direction different from a direction in which the centrifugal force acts;
a support portion provided in the first rotating body or the second rotating body, the support portion configured to moveably guide the centrifugal element in the direction different from the direction in which the centrifugal force acts on the centrifugal element; and
a displacement inhibiting mechanism configured to generate circumferential force which reduces a relative displacement of the first rotating body and the second rotating body when the centrifugal element moves in the direction different from the direction in which the centrifugal force acts on the centrifugal element.

2. The torque fluctuation inhibiting device according to claim 1, wherein
the support portion includes a first wall portion extending in the direction different from the direction in which the centrifugal force acts on the centrifugal element, and a second wall portion opposing the first wall portion in a circumferential direction;
the centrifugal element is disposed between the first wall portion and the second wall portion; and
the centrifugal element is movable in the direction different from the direction in which the centrifugal force acts on the centrifugal element along at least one of the first wall portion and the second wall portion.

3. The torque fluctuation inhibiting device according to claim 1, wherein
the centrifugal element is subject to a turning moment about an axis parallel to a center of rotation of the first rotating body, so as to make contact with the support portion.

4. The torque fluctuation inhibiting device according to claim 3, wherein
the centrifugal element includes a first centrifugal element subject to a first turning moment, and a second centrifugal element subject to a second turning moment opposite to the first turning moment.

5. The torque fluctuation inhibiting device according to claim 1, wherein,
with a first straight line connecting the center of rotation of the first rotating body and a center of gravity of the centrifugal element as a reference, the centrifugal element disposed on a first rotational direction side and the centrifugal element disposed on a second rotational direction side opposite to the first rotational direction side have substantially the same mass.

6. The torque fluctuation inhibiting device according to claim 1, wherein,
with a first straight line connecting the center of rotation of the first rotating body and a center of gravity of the centrifugal element as a reference, the centrifugal element disposed on a first rotational direction side and the centrifugal element disposed on a second rotational direction side opposite to the first rotational direction side have different masses.

7. The torque fluctuation inhibiting device according to claim 1, wherein
the displacement inhibiting mechanism includes a cam mechanism,
the cam mechanism configured to, when relative displacement in a rotational direction occurs between the first rotating body and the second rotating body, convert the centrifugal force into circumferential force in a direction in which the relative displacement reduces.

8. The torque fluctuation inhibiting device according to claim 7, wherein
the cam mechanism includes:
a cam provided in one of the second rotating body and the centrifugal element; and
a cam follower provided in the other of the second rotating body and the centrifugal element, the cam follower configured to move along the cam.

9. The torque fluctuation inhibiting device according to claim 8, wherein
the direction different from the direction in which the centrifugal force acts on the centrifugal element differs from a direction in which a second straight line connecting the center of rotation of the first rotating body and a point of contact between the cam and the cam follower under a state subject to the centrifugal force with no relative displacement extends.

10. The torque fluctuation inhibiting device according to claim 1, wherein
an outer peripheral surface of the first rotating body includes a plurality of recesses open externally in a radial direction, the centrifugal element housed in a recess of the plurality of recesses;
the centrifugal element includes a first guide roller rotatably mounted to a first side portion in the circumferential direction, and a second guide roller rotatably mounted to a second side portion in the circumferential direction; and
the support portion includes a first wall portion in the recess against which the first guide roller abuts, and a second wall portion in the recess against which the second guide roller abuts.

11. The torque fluctuation inhibiting device according to claim 10, wherein
the first guide roller and the second guide roller each include an outer peripheral roller and an inner peripheral roller disposed radially inward of the outer peripheral roller.

12. The torque fluctuation inhibiting device according to claim 1, wherein
the second rotating body includes a first inertia ring and a second inertia ring sandwiching and opposing the first rotating body, and a pin linking the first inertia ring and the second inertia ring such that the first inertia ring and the second inertia ring are unrotatable relative to each other; and
the centrifugal element is disposed between the first inertia ring and the second inertia ring in an axial direction at an outer peripheral portion of the first rotating body and on an inner peripheral side of the pin.

13. A torque converter disposed between an engine and a transmission, the torque converter comprising:
an input-side rotational body which receives torque from the engine;
an output-side rotational body which outputs torque to the transmission;
a damper disposed between the input-side rotational body and a turbine; and
the torque fluctuation inhibiting device of claim 1.

14. A power transmission device comprising:
a flywheel including a first inertial body which rotates about a rotational axis, a second inertial body which rotates about the rotational axis and rotates relative to the first inertial body, and a damper disposed between the first inertial body and the second inertial body;
a clutch device provided to the second inertial body of the flywheel; and
the torque fluctuation inhibiting device of claim 1.
